(19) United States
(12) Patent Application Publication
(10) Pub. No.: US 2018/0341972 A1
(43) Pub. Date: Nov. 29, 2018

(54) SYSTEM AND METHOD FOR DISTRIBUTING SALES PROFIT

(71) Applicant: SV INC., Seoul (KR)

(72) Inventors: Yong Hyun Kang, Suwon-si (KR); Du Hyun Kim, Seoul (KR)

(21) Appl. No.: 16/056,273

(22) Filed: Aug. 6, 2018

Related U.S. Application Data
(63) Continuation of application No. PCT/KR2017/000762, filed on Jan. 23, 2017.

(30) Foreign Application Priority Data
Feb. 6, 2016 (KR) 10-2016-0015339
May 2, 2016 (KR) 10-2016-0054321

(51) Int. Cl. G06Q 30/02

(52) U.S. Cl. CPC G06Q 30/0234; G06Q 30/0215; G06Q 30/0211; G06Q 30/0238

(57) ABSTRACT

The disclosed technology for distributing a portion of a sales profit to purchasers if a product selling event is successful, thereby promoting product sales, wherein the sales profit distribution system may include a product payment unit adapted to allow a payment for the product to be made through a terminal of the purchaser; and a profit distribution unit adapted to calculate an individual distribution profit to be distributed to the purchaser from the distribution profit, and the sales profit distribution method may include the steps of: (a) performing a payment for the product by a terminal of the purchaser through a product payment unit; and (b) calculating an individual distribution profit to be distributed to the purchaser from the distribution profit through a profit distribution unit.

### CROSS-REFERENCE TO RELATED APPLICATIONS

This patent document claims priority to and the benefit of PCT Application No. PCT/KR2017/000762 filed on Jan. 23, 2017 which claims priorities to Korean Patent Application No. 10-2016-0015339 filed on Feb. 6, 2016 and Korean Patent Application No. 10-2016-0054321 filed on May 2, 2016. The above applications are all hereby incorporated by reference for all purposes as if fully set forth herein.

### TECHNICAL FIELD

Some implementations of the disclosed technology relate to a sales profit distribution system and method.

### BACKGROUND

A consumption behavior in a conventional economic system is carried out by paying for a product in cash to obtain the product. Under such a structure, as more consumption is made, the assets of a consumer are reduced, so that the consumer has to stop or cut down his or her consumption so as to increase or maintain his or her assets.

If an economic depression occurs, the consumer reduces his or her consumption, and thus, product sales are reduced. Subsequently, product sellers reduce the number of workers or their wage due to the decrease of their sales, and therefore, the consumer's income becomes reduced, so that he or she reduces the consumption more and more, thereby making such a vicious circle to be repeated under such a structure.

If the assets of the consumer are increased as he or she increases consumption, however, the opposite phenomena to those mentioned above may occur. In detail, the consumer increases his or her consumption more, and accordingly, product sales are drastically increased. Also, the product sellers increase the number of workers or their wage through the drastic increase of their sales. Therefore, the consumer's income increases as well, which allows his or her consumption to increase as well. If such an economic system is achieved and continued, the world economy will be in the boom years.

### SUMMARY

Various implementations are provided to introduce a unique manner of distributing a portion of a sales profit to purchasers, if a product selling event is successful, to increase the assets of the purchasers, so that the product sales are promoted.

### Technical Solution

Some implementation of the disclosed technology provides a sales profit distribution system adapted to distribute a distribution profit to a purchaser who purchases a product when a target amount of product sales is reached within a target period of time for the product sales and to include a product payment unit adapted to allow a payment for the product to be made through a terminal of the purchaser; and a profit distribution unit adapted to calculate an individual distribution profit to be distributed to the purchaser from the distribution profit.

In some implementations, the profit distribution unit may perform a method of calculating the individual distribution profit, the method including the steps of: arranging the purchasers in an order of payment; paying a first individual distribution profit calculated by multiplying the distribution profit by a distribution rate of the distribution profit to a first purchaser who performs an earliest payment among the purchasers; and paying a second individual distribution profit calculated by multiplying an amount remained after subtracting the first individual distribution profit from the distribution profit by the distribution rate of the distribution profit to a second purchaser who performs a second earliest payment among the purchasers.

In some implementations, the sales profit distribution system may further include a member account unit allocated to a member who is joined in the sales profit distribution system to deposit at least one of cyber money and cash thereinto, and the profit distribution unit may perform a method of calculating the individual distribution profit, the method including the steps of: arranging the purchasers in an order of a cyber money amount deposited into member account unit of the purchaser; paying a first individual distribution profit calculated by multiplying the distribution profit by the distribution rate of the distribution profit to a first purchaser who has a largest cyber money amount among the purchasers; and paying a second individual distribution profit calculated by multiplying an amount remained after subtracting the first individual distribution profit from the distribution profit by the distribution rate of the distribution profit to a second purchaser who has a second largest cyber money amount among the purchasers.

In some implementations, the sales profit distribution system may further include a member account unit allocated to a member who is joined in the sales profit distribution system to deposit at least one of cyber money and cash thereinto, and the profit distribution unit may perform a method of calculating the individual distribution profit, the method including the steps of: arranging the purchasers in an order of a value calculated by multiplying a cyber money amount deposited into the member account unit of the purchaser by the number of the payments of the purchaser (hereinafter, referred to as a “cyber money amount for order”); paying a first individual distribution profit calculated by multiplying the distribution profit by the distribution rate of the distribution profit to a first purchaser who has a largest cyber money amount for order among the purchasers; and paying a second individual distribution profit calculated by multiplying an amount remained after subtracting the first individual distribution profit from the distribution profit by the distribution rate of the distribution profit to a second purchaser who has a second largest cyber money amount for order among the purchasers.

In some implementations, the sales profit distribution system may further include a purchase confirmation management unit adapted to transmit a purchase confirmation request to a terminal of the purchaser and to receive a purchase confirmation response or a purchase cancel response as a response to the purchase confirmation request from the terminal of the purchaser, and the profit distribution unit may perform a method of calculating the individual distribution profit, the method comprising the steps of: arranging the purchasers in an order of purchase confirmation response; paying a first individual distribution profit calculated by multiplying the distribution profit by the distribution rate of the distribution profit to a first purchaser who transmits an earliest purchase confirmation response among the purchasers; and paying a second individual distribution profit calculated by multiplying an amount remained after subtracting the first individual distribution profit from the distribution profit by the distribution rate of the distribution profit to a second purchaser who transmits a second earliest purchase confirmation response among the purchasers.

Some implementation of the disclosed technology provides a sales profit distribution method distributing a distribution profit to a purchaser who purchases a product when a target amount of product sales is reached within a target period of time for the product sales and including the steps of: (a) performing a payment for the product by a terminal of the purchaser through a product payment unit; and (b) calculating an individual distribution profit to be distributed to the purchaser from the distribution profit through a profit distribution unit.

In some implementations, the step (b) may include the steps of: arranging the purchasers in an order of payment; paying a first individual distribution profit calculated by multiplying the distribution profit by a distribution rate of the distribution profit to a first purchaser who performs an earliest payment among the purchasers; and paying a second individual distribution profit calculated by multiplying an amount remained after subtracting the first individual distribution profit from the distribution profit by the distribution rate of the distribution profit to a second purchaser who performs a second earliest payment among the purchasers.

In some implementations, the step (b) may include the steps of: arranging the purchasers in an order of a cyber money amount deposited into member account unit of the purchaser; paying a first individual distribution profit calculated by multiplying the distribution profit by the distribution rate of the distribution profit to a first purchaser who has a largest cyber money amount among the purchasers; and paying a second individual distribution profit calculated by multiplying an amount remained after subtracting the first individual distribution profit from the distribution profit by the distribution rate of the distribution profit to a second purchaser who has a second largest cyber money amount among the purchasers.

In some implementations, the step (b) may include the steps of: arranging the purchasers in an order of a value calculated by multiplying a cyber money amount unit deposited into the member account of the purchaser by the number of the payments of the purchaser (hereinafter, referred to as a “cyber money amount for order”); paying a first individual distribution profit calculated by multiplying the distribution profit by the distribution rate of the distribution profit to a first purchaser who has a largest cyber money amount for order among the purchasers; and paying a second individual distribution profit calculated by multiplying an amount remained after subtracting the first individual distribution profit from the distribution profit by the distribution rate of the distribution profit to a second purchaser who has a second largest cyber money amount for order among the purchasers.

In some implementations, the sales profit distribution method may further include, before the step (b), the steps of transmitting a purchase confirmation request to a terminal of the purchaser and receiving a purchase confirmation response or a purchase cancel response as a response to the purchase confirmation request from the terminal of the purchaser through a purchase confirmation management unit, and the step (b) may include the steps of: arranging the purchasers in an order of purchase confirmation response; paying a first individual distribution profit calculated by multiplying the distribution profit by the distribution rate of the distribution profit to a first purchaser who transmits an earliest purchase confirmation response among the purchasers; and paying a second individual distribution profit calculated by multiplying an amount remained after subtracting the first individual distribution profit from the distribution profit by the distribution rate of the distribution profit to a second purchaser who transmits a second earliest purchase confirmation response among the purchasers.

According to the implementations of the disclosed technology, a mechanism is provided for distributing a portion of sales profit to the purchasers, if the product selling event is successful, to increase the assets of the purchasers, so that the product sales are promoted.

### DESCRIPTION OF DRAWINGS

FIG. 1 is an exemplary block diagram showing a configuration of a sales profit distribution system according to an implementation of the disclosed technology.

FIG. 2 is an exemplary block diagram showing a configuration of a sales profit distribution system according to another implementation of the disclosed technology.

FIG. 3 is an exemplary flowchart showing processes of selling products and distributing a sales profit in the sales profit distribution system according to another implementation of the disclosed technology, wherein a purchaser makes a payment for a sales price on an event configured by a seller and performs a purchase confirmation response.

FIG. 4 is an exemplary flowchart showing processes of selling products and distributing a sales profit in the sales profit distribution system according to another implementation of the disclosed technology, wherein a purchaser makes a payment for a sales price on the event configured by the seller and performs a purchase cancel response.

### DETAILED DESCRIPTION

The disclosed technology can be implemented to provide a product sales promotion system and method. Therefore, there is a need for a system capable of providing a new economic structure wherein the cash assets of the consumer are increased as his or her consumption is increased.

Hereinafter, various implementations of the disclosed technology will be described in detail with reference to the accompanying drawings so that those skilled in the art can easily carry out the disclosed technology. In the following detailed description of the embodiments of the disclosed technology, a detailed description of known functions or configurations will be omitted. The same reference numerals are used throughout the drawings for portions having similar functions and actions. Hereinafter, a product sales promotion system and method according to an implementation of the disclosed technology will now be described in detail with reference to the attached drawings.

In addition, in the entire specification, when a part is referred to as being “connected” with another part, it is not only a case where it is directly connected, but also a case where it is indirectly connected with another element therebetween. Also, “comprising” and “including” mean that other components may be included, rather than excluding other components, unless specifically stated otherwise.

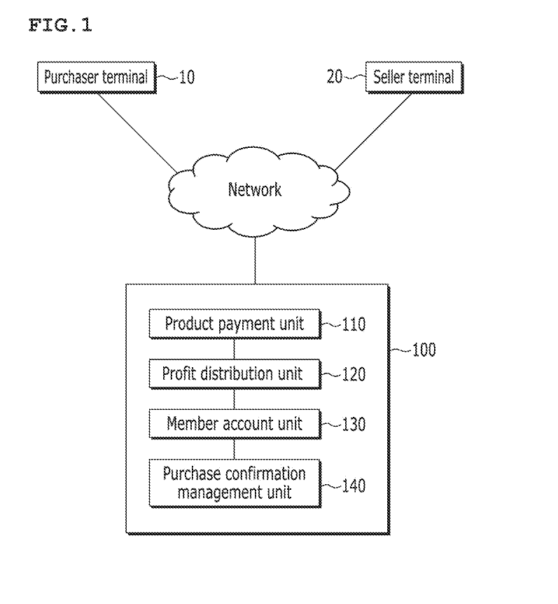

FIG. 1 is an exemplary block diagram showing a configuration of a sales profit distribution system according to an implementation of the disclosed technology.

A sales profit distribution system 100 according to an implementation of the disclosed technology relates to a system for distributing a distribution profit to a purchaser who purchases a product when a target amount of product sales is reached within a target period of time for the product sales, and may include a product payment unit 110 and a profit distribution unit 120, adapted to calculate an individual distribution profit to be distributed to the purchaser from the distribution profit. The event may be configured by a seller or the system.

The term “unit” as used herein may include software, hardware, or a combination thereof depending on the context in which the term is used. For example, the software may be machine code, firmware, embedded code, application software, or a combination thereof. Also, for example, the hardware may be a circuit, a processor, a computer, an integrated circuit, integrated circuit cores, or a combination thereof. The units may be implemented in one computer in some applications, or may be distributed in more than one computers or servers linked to a communication network to allow communications between the units. The produce sales promotion system which is communicatively connected with the purchaser terminal and the seller terminal to receive relevant information from the seller terminal and/or the purchaser terminal.

A purchaser may be connected to the sales profit distribution system 100 by using a purchaser terminal 10 through the wired and wireless network. The purchaser terminal 10 may be or include devices for transmitting and receiving data to and from the sales profit distribution system 100 connected thereto, and for example, desktop computers, laptops, smart phones, tablet computers, and so on may be used as the purchaser terminal 10. However, the purchaser terminal 10 is not limited to those mentioned above.

If the event is activated, the purchaser may purchase the product through the purchaser terminal 10. So as to purchase the product, the purchaser may make a payment for the sales price of the product on a payment screen provided by the product payment unit 110 through the purchaser terminal 10.

If the number of products sold for a target period of time for product sales reaches the target amount of product sales to thus finish the event, the profit distribution unit 120 may calculate an individual distribution profit to be distributed to the purchaser from a distribution profit.

The profit distribution unit 120 may distribute the distribution profit according to the order of payment. The profit distribution unit 120 arranges the purchasers in the order of payment. Next, the profit distribution unit 120 pays a first individual distribution profit calculated by multiplying the distribution profit by a distribution rate of the distribution profit to a first purchaser who performs the earliest payment among the purchasers, and then pays a second individual distribution profit calculated by multiplying an amount remained after subtracting the first individual distribution profit from the distribution profit by the distribution rate of the distribution profit to a second purchaser who performs the second earliest payment among the purchasers.

The sales profit distribution system 100 according to an implementation of the disclosed technology may further include a member account unit 130.

The purchaser may be a member who joins the sales profit distribution system 100, and the members of the sales profit distribution system 100 may have cyber money accounts and cash accounts connected to their own accounts. The cyber money accounts and the cash accounts may be included in the member account unit 130. The cyber money deposited into the cyber money accounts may be used as a distribution standard when a distribution profit is distributed, and the individual distribution profit is put into the cyber money accounts in the form of cyber money. However, the individual distribution profit may be transferred to the cash account in the form of cash.

The profit distribution unit 120 may distribute the distribution profit according to the amount of cyber money retained. The profit distribution unit 120 arranges the purchasers in the order of the cyber money amount deposited into the member account unit 130 of the purchaser. Next, the profit distribution unit 120 pays a first individual distribution profit calculated by multiplying the distribution profit by the distribution rate of the distribution profit to a first purchaser who has the largest cyber money amount among the purchasers, and then pays a second individual distribution profit calculated by multiplying an amount remained after subtracting the first individual distribution profit from the distribution profit by the distribution rate of the distribution profit to a second purchaser who has the second largest cyber money amount among the purchasers.

Further, the profit distribution unit 120 may distribute the distribution profit according to the amount of cyber money retained and the number of payments. The profit distribution unit 120 arranges the purchasers in the order of a value calculated by multiplying a cyber money amount deposited into the member account unit of the purchaser by the number of the payments of the purchaser (hereinafter, referred to as a “cyber money amount for order”). Next, the profit distribution unit 120 pays a first individual distribution profit calculated by multiplying the distribution profit by the distribution rate of the distribution profit to a first purchaser who has the largest cyber money amount for order among the purchasers, and then pays a second individual distribution profit calculated by multiplying an amount remained after subtracting the first individual distribution profit from the distribution profit by the distribution rate of the distribution profit to a second purchaser who has the second largest cyber money amount for order among the purchasers. For example, if one purchaser makes five payments, the cyber money amount for order of the purchaser is calculated as the amount of cyber money retained*5.

The sales profit distribution system according to an implementation of the disclosed technology may further include a purchase confirmation management unit 140.

The purchase confirmation management unit 140 may transmit a purchase confirmation request to the purchaser who receives the purchased product and may receive a purchase confirmation response or a purchase cancel response as a response to the purchase confirmation request from the purchaser terminal 10.

The purchase confirmation response is the purchaser's willingness to get no refund, and the purchase cancel response is the purchaser's willingness to get a refund.

The profit distribution unit 120 may distribute the distribution profit according to the order of purchase confirmation response. The profit distribution unit 120 arranges the purchasers in the order of purchase confirmation response. Next, the profit distribution unit 120 pays a first individual distribution profit calculated by multiplying the distribution profit by the distribution rate of the distribution profit to a first purchaser who transmits the earliest purchase confirmation response among the purchasers, and then pays a second individual distribution profit calculated by multiplying an amount remained after subtracting the first individual distribution profit from the distribution profit by the distribution rate of the distribution profit to a second purchaser who transmits the second earliest purchase confirmation response among the purchasers.

In the distribution ways of the distribution profit as mentioned above, examples only for the first and second purchase confirmation purchasers are suggested, but in the same manner as above, individual distribution profits may be paid to the purchase confirmation purchasers in the post-order. For example, a third individual distribution profit calculated by multiplying the amount remained after subtracting the first individual distribution profit and the second individual distribution profit from the distribution profit by the distribution rate of the distribution profit may be paid to a third purchase confirmation purchaser.

If the distribution profit remains after the individual distribution profits are paid to all of the purchase confirmation purchasers, another first individual distribution profit calculated by multiplying the remaining distribution profit by the distribution rate of the distribution profit may be paid to the first purchase confirmation purchasers again and then the distribution of the remaining distribution profit may proceed in the same manner as above. If the remaining distribution profit is less than a predetermined amount, however, the profit distribution unit 120 may finish the distribution of the individual distribution profit.

The sales profit distribution system 100 according to an implementation of the disclosed technology may be applied to a variety of online sales systems, and hereinafter, a sales profit distribution system 200 according to another implementation of the disclosed technology will be explained.

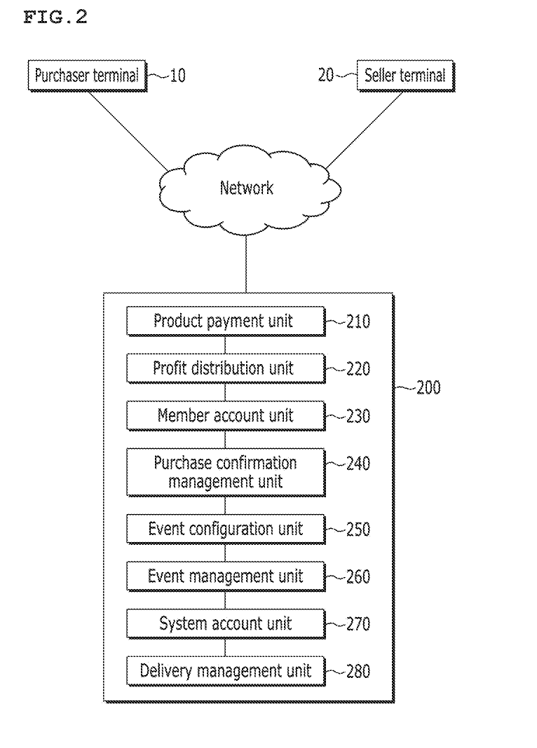

FIG. 2 is an exemplary block diagram showing a configuration of a sales profit distribution system according to another implementation of the disclosed technology.

A sales profit distribution system 200 according to another implementation of the disclosed technology may include a product payment unit 210, a profit distribution unit 220, a member account unit 230, a purchase confirmation management unit 240, an event configuration unit 250, an event management unit 260, a system account unit 270 and a delivery management unit 280.

A purchaser may be connected to the sales profit distribution system 200 by using a purchaser terminal 10 through the wired and wireless network. A seller may be connected to the sales profit distribution system 200 by using a seller terminal 20 through wired and wireless network. The purchaser terminal 10 and the seller terminal 20 may be devices for transmitting and receiving data to and from the sales profit distribution system 200 connected thereto, and for example, desktop computers, laptops, smart phones, tablet computers, and so on may be used as the seller terminal 20 and the purchaser terminal 10. However, the purchaser terminal 10 and the seller terminal 20 are not limited to those mentioned above.

The seller and the purchaser may be members who join the sales profit distribution system 200, and the members of the sales profit distribution system 200 may have cyber money accounts and cash accounts connected to their own accounts. The cyber money accounts and the cash accounts may be included in the member account unit 230. The cyber money deposited into the cyber money accounts may be used to decide distribution amounts for the respective purchasers. Thus, the cyber money deposited into the cyber money accounts may provide a distribution standard for distributing a distribution profit, which will be discussed later, and the distribution profit are put into the cyber money accounts in the form of cyber money. However, the distribution profit may be transferred to the cash account in the form of cash. The cash in the cash accounts may be transferred to the cyber money accounts, exchanged with the cyber money in the ratio of 1:1 or in a predetermined ratio, and deposited into the cyber money accounts. Contrarily, the cyber money in the cyber money accounts may be transferred to the cash accounts, but in this case, a withdrawal fee at a predetermined percentage for the transferring money may be paid. The cyber money may be referred to as different names, for example, reward points, mileages, coupons, credits, gifts, incentives, energy currency, etc.

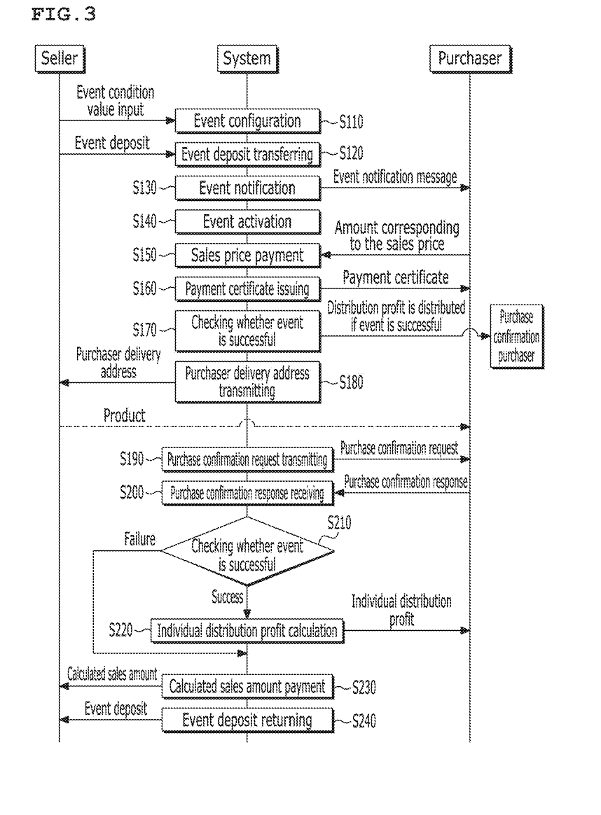

FIG. 3 is an exemplary flowchart showing the processes of selling products and distributing sales profit in the sales profit distribution system according to another implementation of the disclosed technology, wherein the purchaser makes a payment for a sales price on an event configured by the seller and performs a purchase confirmation response.

The seller is connected to the sales profit distribution system 200 by using the seller terminal 20, and he or she selects an event configuration menu so as to configure an event to be successful when a target amount of product sales is achieved for a target period of time for product sales. The event configuration unit 250 displays, on the seller terminal 20, an input screen where, as event condition values, the sales price of a product, the target period of time for product sales, the target amount of product sales, distribution profit to be distributed to the purchasers performing purchase confirmation responses if the event is successful, a distribution way of the distribution profit, and a distribution rate of the distribution profit are inputted, and the seller inputs, on the seller's terminal 10, the sales price of the product to be sold through the sales profit distribution system 200, the target period of time for product sales, the target amount of product sales, the distribution profit, the distribution way of the distribution profit, and the distribution rate of the distribution profit. The values inputted to the event configuration unit 250 through the seller terminal 20 are stored in the event configuration unit 250, thereby completing configuring the event (at step S110).

If the payment for the sales price of the product is made, a payment certificate is issued by the event management unit 260, and if the number of payment certificates reaches the target amount of product sales, it is considered that the event is successful.

The sales price of the product, the target period of time of product sales, the target amount of product sales, distribution profit, the distribution way of the distribution profit, and the distribution rate of the distribution profit may be arbitrarily determined by the seller, and some of them may be suggested with appropriate values by means of the sales profit distribution system 200. Further, some of them may be in advance calculated as optimized values by means of the sales profit distribution system 200 and provided as fixed values.

The event management unit 260 transmits, a message that the amount corresponding to the distribution profit, as the event deposit, must be deposited into the system account unit 270, to the seller terminal 20. Through the seller terminal 20, the seller requests the event management unit 260 to transfer the event deposit having the same amount as the distribution profit from the cyber money account or cash account connected to the seller's account to the system account unit 270, and the event management unit 260 transfers the event deposit from the cyber money account or cash account of the seller to the system account unit 270 (at step S120). The cash may be transferred to the system account unit 270, and in case where the cash is transferred as the event deposit from the cyber money account to the system account unit 270, the withdrawal fee may occur so that the amount corresponding to the event deposit and the withdrawal fee may be withdrawn from the cyber money account.

Before the event is activated, the event management unit 260 may transfer an event notification message of notifying the members joined in the sales profit distribution system 200 of the start date and start time of the event activation to the terminals of the members (at step S130). As the start date and start time of the event activation are in advance notified, fair sales can be ensured in case where the distribution way of the distribution profit is determined according to the order of payment (that is, the payment certificate issue order) or the order of purchase confirmation response. As a result, the event notification message can prevent the first occupation in the distribution order of the distribution profit by the purchasers who in advance obtain the event information.

Before the activation of the event, further, the event management unit 260 may notify the members of a period of time during which it is possible to start the event, and it is possible to unexpectedly start the activation of the event within the period of time. In detail, the event management unit 260 may notify the members of a period of time during which it is possible to start the event, for example, between May 1, 2016 and May 8, 2106, and without any additional notification, the event may be activated on May 3, 2016, 1 pm.

The event management unit 260 may activate the event configured through the event configuration unit 250 by the seller terminal 20 of the seller (at step S140). Before the event is activated by the seller, the event management unit 260 may request the seller terminal 20 to deposit a system usage fee, and if it is checked that the system usage fee is deposited into the system account unit 270, the event management unit 260 may activate the event.

In the state where the event notification message is not sent to the members joined in the sales profit distribution system 200 before the activation of the event, it is possible that the event is activated on the start date and time of the event, without any notification.

The event management unit 260 may activate the event after a predetermined standby period from the start time of the event, not on the start time of the event set in the event configuration unit 250 through the seller terminal 20 of the seller. In case where the distribution way of the distribution profit is determined according to the order of payment (that is, the payment certificate issue order) or the order of purchase confirmation response, accordingly, fair sales can be ensured. For the predetermined standby period, in detail, the members can obtain the event information, thereby preventing the first occupation in the distribution order of the distribution profit by the purchasers who in advance obtain the event information.

If the event is activated through the event management unit 260 (at the step S140), the product may be purchased through the purchaser terminal 10 of the purchaser.

So as to purchase the product, the purchaser makes a payment for the sales price on the payment screen provided through the product payment unit 210 by the purchaser terminal 10, and the product payment unit 210 deposits the paid amount for the sales price into the system account unit 270 (at step S150). The paid amount for the sales price may be the cyber money and/or the cash withdrawn from the cyber money account and/or cash account of the purchaser, card sales amount received from a credit card company of the purchaser, and payment amount received from a smart phone communication company of the purchaser. The payment ways include known online payment ways, and a detailed explanation on the payment ways will be omitted.

If the payment for the sales price is made, the event management unit 260 may issue the payment certificate and may transmit the payment certificate to the purchaser terminal 10 (at step S160).

Whenever the event management unit 260 issues the payment certificates for the respective purchasers, it checks whether the event is successful (at step S170). As the target amount of product sales is accomplished through the purchaser who makes payment for the sales price, it may be checked whether the event is successful. If it is checked that the event is successful through the purchasers who make payments for the sales price, the distribution profit starts to be distributed to the other purchasers who have purchased the products, have performed the purchase confirmation responses, and have been waiting for the event success.

The delivery management unit 280 may transmit a delivery address and a payment certificate of the purchaser who makes a payment for the sale price to the seller terminal 20 to allow the seller to deliver the product to the purchaser (at step S180). A delivery way may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 240 may transmit the purchase confirmation request to the purchaser who receives the product through the delivery service or directly receives the product from the seller (at step S190).

The purchase confirmation management unit 240 may receive the response to the purchase confirmation request from the purchaser (at step S200). The response to the purchase confirmation request is either the purchase confirmation response or the purchase cancel response. Hereinafter, an explanation on the case where the response to the purchase confirmation request is the purchase confirmation response will be given.

If the purchase confirmation management unit 240 receives the purchase confirmation response from the purchaser, the event management unit 260 may check whether the event is successful (at step S210). If the event management unit 260 checks that the number of payment certificates issued by the payments for the products reaches the target amount of product sales, it is determined that the event is successful, and the profit distribution unit 220 may pay an individual distribution profit calculated from the distribution profit, in cyber money, to the purchaser who performs the purchase confirmation response (at step S220). The profit distribution unit 220 may apply the distribution way of the distribution profit and the distribution rate of the distribution profit to the distribution profit to calculate the individual distribution profit. The individual distribution profit may be withdrawn from the amount kept in the system account unit 270 and may be transferred to the cyber money account of the purchaser who performs the purchase confirmation response. The distribution profit is paid in cyber money, but it is possible that the distribution profit is transferred, in cash, to the cash account of the purchaser who performs the purchase confirmation response.

After the individual distribution profit is paid through the profit distribution unit 220 (at the step S220), the event management unit 260 may transfer the sales amount calculated by subtracting the sum of the paid individual distribution profits from the total sales amount (calculated by multiplying the sales price by the number of purchase confirmed products) to the cash account of the seller (at step S230) and may return the event deposit in the system account unit 270 to the cash account of the seller (at step S240). In this case, an explanation on S210, S220, S230 and S240 which are sequentially performed is paid, but the steps may be performed concurrently or in a reverse order to each other.

If it is checked by the event management unit 260 that the number of payment certificates issued by the payments for the products does not reach the target amount of product sales (at the step S210), it is determined that the event fails. If the event fails, the step of distributing the individual distribution profit (at the step S220) is not performed.

If the event fails, the event management unit 260 may transfer the total sales amount (calculated by multiplying the sales price by the number of purchase confirmed products) to the cash account of the seller (at the step S230) and may return the event deposit in the system account unit 270 to the cash account of the seller (at the step S240). In this case, an explanation on the steps S210, S230 and S240 which are sequentially performed is paid, but the steps may be performed concurrently or in a reverse order to each other.

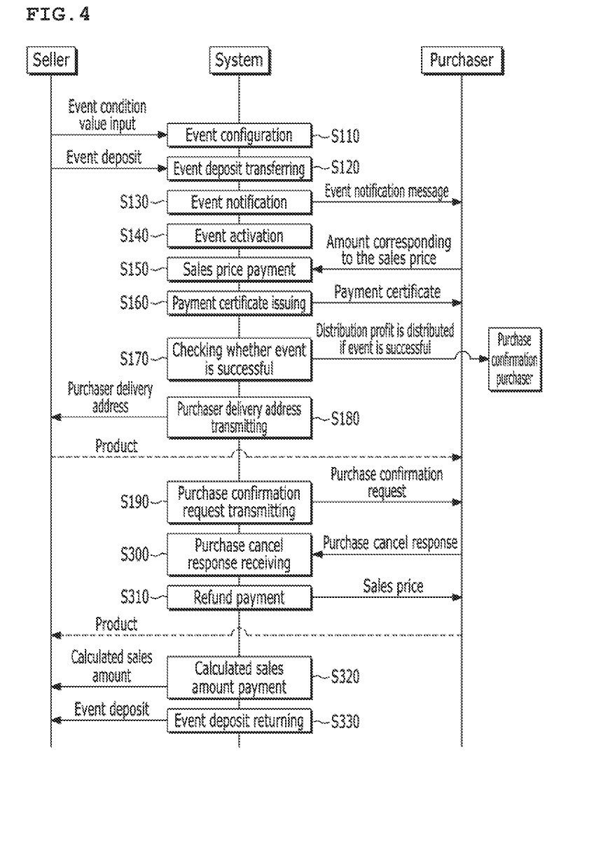

FIG. 4 is an exemplary flowchart showing the case where the purchase confirmation management unit 240 at the step S220 of FIG. 3 receives the purchase cancel response from the purchaser, wherein since the steps S110 to S190 are the same as those of FIG. 3, an explanation on them will be omitted, and accordingly, the step S200 of FIG. 3 (corresponding to step S300 of FIG. 4) and the steps after the step S230 will be explained in detail.

The purchase confirmation management unit 240 may transmit the purchase confirmation request to the purchaser (at the step S190).

The purchase confirmation management unit 240 may receive the response to the purchase confirmation request from the purchaser (at the step S300). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund in case where the purchased product is unsatisfied.

If the purchase confirmation management unit 240 receives the purchase cancel response from the purchaser (at step S300), the profit distribution unit 220 pays the amount corresponding to the sales price, as a refund, to the purchaser who performs the purchase cancel response (at step S310). The refund may be withdrawn from the amount kept in the system account unit 270 and thus may be transferred to the cash account of the purchaser who performs the purchase cancel response.

After the profit distribution unit 220 pays the individual distribution profits to the purchasers who perform the purchase confirmation response, the event management unit 260 may transfer the sales amount calculated by subtracting the sum of the paid individual distribution profits from the total sales amount (calculated by multiplying the sales price and the number of purchase confirmed products) to the cash account of the seller (at step S320) and may return the event deposit in the system account unit 270 to the cash account of the seller (at step S330).

An expected distribution order in the sales profit distribution system and method according to an implementation of the disclosed technology may be calculated before the purchase confirmation responses of the purchasers are completed. Whenever the payment certificates are issued by the event management unit 260, the profit distribution unit 220 may calculate an expected distribution order of the purchasers in real time to transmit the real time expected distribution order to the terminals 10 of the purchasers.

In this case, of course, the profit distribution unit 220 may not publish the real time expected distribution order until the event is successful, and after the event is successful, the profit distribution unit 220 may transmit the real time expected distribution order to the terminals 10 of the purchasers. Until the event is successful, as a result, the purchasers cannot obtain the information on their real time expected distribution order, so that such uncertainty in the real time expected distribution order makes purchase desires more stimulated, thereby allowing the event to be successful within a shorter period of time.

The distribution way of the distribution profit in the sales profit distribution system and method according to another implementation of the disclosed technology may be selected by the seller. For example, the distribution way of the distribution profit may be determined according to the order of payment (that is, the payment certificate issue order), an amount of cyber money retained, or the order of purchase confirmation response.

The distribution way of the distribution profit according to the order of payment may be carried out by arranging purchasers who perform the purchase confirmation responses (hereinafter, referred to as “purchase confirmation purchasers”) in the order of payment. First, a first individual distribution profit calculated by multiplying the distribution profit by a distribution rate may be paid to a first purchase confirmation purchaser who performs the earliest payment among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who performs the payment in the second earliest among the purchase confirmation purchasers.

The distribution way of the distribution profit according to the amount of cyber money retained is carried out by arranging the purchase confirmation purchasers in the order of the cyber money amount of the cyber money account allocated to the account of the purchase confirmation purchaser. In this case, the cyber money deposited into the cyber money account may include the cyber money exchanged from the cash of the purchase confirmation purchaser, and the cyber money deposited as distribution profit transferred from other events. Next, a first individual distribution profit calculated by multiplying the distribution profit by the distribution rate of the distribution profit is paid to a first purchase confirmation purchaser who has the largest cyber money amount among the purchase confirmation purchasers, and a second individual distribution profit calculated by multiplying the amount remained after subtracting the first individual distribution profit from the distribution profit by the distribution rate of the distribution profit is paid to a second purchase confirmation purchaser who has the second largest cyber money amount among the purchase confirmation purchasers.

The distribution way of the distribution profit according to the amount of cyber money retained is carried out on the basis of the number of the payments of the purchase confirmation purchasers. The distribution way may be carried out by arranging the purchase confirmation purchasers in the order according to a value calculated by multiplying the cyber money amount of the cyber money accounts included in the account of the purchase confirmation purchaser by the number of payment certifications issued to the purchase confirmation purchaser (hereinafter, referred to as a “cyber money amount for order”). In this case, the cyber money deposited into the cyber money account may include the cyber money exchanged from the cash of the purchase confirmation purchaser, and the cyber money deposited as distribution profit transferred from other events. Then, a first individual distribution profit calculated by multiplying the distribution profit by the distribution rate of the distribution profit may be paid to a first purchase confirmation purchaser who has the largest cyber money amount for order among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who has the second largest cyber money amount for order among the purchase confirmation purchasers. For example, if one purchase confirmation purchaser receives five payment certificates, the cyber money amount for order of the purchase confirmation purchaser is calculated as the amount of cyber money retained*5. The distribution way of the distribution profit according to the order of purchase confirmation response may be carried out by arranging the purchase confirmation purchasers in the order of purchase confirmation response. First, a first individual distribution profit calculated by multiplying the distribution profit by the distribution rate of the distribution profit may be paid to a first purchase confirmation purchaser who performs the earliest purchase confirmation response among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who performs the purchase confirmation response in the second earliest among the purchase confirmation purchasers.

In the distribution ways of the distribution profit as mentioned above, examples only for the first and second purchase confirmation purchasers are suggested, but in the same manner as above, individual distribution profits may be paid to the purchase confirmation purchasers in the post-order. For example, a third individual distribution profit calculated by multiplying the amount remained after subtracting the first individual distribution profit and the second individual distribution profit from the distribution profit by the distribution rate of the distribution profit may be paid to a third purchase confirmation purchaser.

If the distribution profit remains after the individual distribution profits are paid to all of the purchase confirmation purchasers, another first individual distribution profit calculated by multiplying the remaining distribution profit by the distribution rate of the distribution profit may be paid to the first purchase confirmation purchasers again and then the distribution of the remaining distribution profit may proceed in the same manner as above. If the remaining distribution profit is less than a predetermined amount, however, the profit distribution unit 220 may transfer the remaining distribution profit into the system account unit 270 and may finish the distribution of the distribution profit.

Now, an explanation on the effects obtained by the sales profit distribution system and method according to an implementation of the disclosed technology will be given with a given example.

One sales agency of a computer manufacturing company A sells a laptop computer X at a retail price of 2,000 dollars. The average number of laptop computers X sold for a month in the sales agency is 50. Actually, the laptop computer is sold at the lowest price of 1,800 dollars on on-line markets. The sales agency determines that they sell the laptop computer X at the lowest price of 1,800 dollars through the sales profit distribution system according to an implementation of the disclosed technology, and the event is configured with the following conditions.
Sales price: 1,800 dollars
Target period of time for product sales: one month
Target amount of product sales: 2,000
Distribution profit to be distributed to purchasers if the event is successful: 780,000 dollars
Distribution way of the distribution profit: distribution according to cyber money amounts retained in the cyber money accounts of purchase confirmation purchasers
Distribution rate of the distribution profit: 0.1%

The sales agency can accomplish the number of laptop computers X sold which is more increased by 40 times than the number of laptop computers X sold for one month in the past, for only one month, which is the same period as in the past, so that the sales agency obtains additional cash of 3,510,000 dollars (=1,800 dollars*1,950) greater than cash of 100,000 dollars for one month in the past. The distribution profit of 780,000 dollars corresponding to about 22% of the additional cash is distributed to the purchasers (If it is desired for the sales agency to sell 1,950 laptop computers X in the conventional manner, a period of three years and three months is needed).

Purchaser B is a first purchaser having the largest cyber money amount among 2,000 purchasers, Purchaser C is a second purchaser having the second largest cyber money amount among the purchasers, Purchaser D is a 500th purchaser having the 500th largest cyber money amount among the purchasers, and Purchaser E is a 2000th purchaser having the 2000th largest cyber money amount among the purchasers. In this case, the cyber money to be distributed to Purchasers B, C, D and E will be calculated as follows.

[Amount to be Paid to Purchaser B]
Individual distribution profit of 780 dollars [=distribution profit of 780,000 dollars*distribution rate of 0.1%]

[Amount to be Paid to Purchaser C]
Individual distribution profit of 779 dollars [=(amount of 779,220 dollars calculated by subtracting the first individual distribution profit of 780 dollars from distribution profit of 780,000 dollars)*(distribution rate of 0.1%)]

[Amount to be Paid to Purchaser D]
Individual distribution profit of 473 dollars [=(amount of 473,449 dollars calculated by subtracting the individual distribution profits of up to 499th purchasers from distribution profit of 780,000 dollars)*(distribution rate of 0.1%)]

[Amount to be Paid to Purchaser E]
Individual distribution profit of 106 dollars [(=amount of 105,562 dollars calculated by subtracting the individual distribution profits of up to 1999th purchasers from distribution profit of 780,000 dollars)*(distribution rate of 0.1%)]

Purchasers B, C, D and E purchase the laptop computer X of 1,800 dollars, which is the same price as the lowest price sold on on-line markets. According to the event success, furthermore, Purchasers B, C, D and E have got the respective individual distribution profits of 780 dollars, 779 dollars, 473 dollars, and 106 dollars in the form of cyber money. With a payment of the withdrawal fee, the cyber money in the cyber money account may be transferred to the cash account or cash may be withdrawn directly from the cyber money account, thereby increasing the cash assets of the purchaser. Further, since the order of the cyber money retention of the purchaser is raised by the cyber money distributed through this purchase, a larger amount of individual distribution profit may be distributed to the purchaser at the time of next purchase.

If the payment of the purchaser is made through the use of an interest-free installment program provided by a credit card company, the profit of the purchaser will be maximized. If the purchaser buys a 2,000 dollar laptop computer in a conventional purchase system, he or she just prepares 2,000 dollars, which makes him or her feel burdened so that he or she does not purchase the laptop computer. Through the sales profit distribution system 200, the sales price is paid in interest-free installments, and next, the installment amount is paid with the individual distribution profit, thereby making the purchase burden of the purchase disappear. Such an advantage is obtained because the value of time is turned into the cyber money. Particularly, if the distribution rate of the distribution profit is raised by the seller, the amount of the distribution profit to be distributed to the top-order purchasers is increased, so that the consumption willingness and event join willingness of the members become high. An example of such a case will be explained later.

For a short period of time, of course, the seller accomplishes a significantly larger amount of sales than an amount of sales in the past, thereby obtaining a great sales profit, and even if the distribution profit is distributed, an amount of sales over several months to years can be obtained within the short period of time, so that no financial damage occurs. So as to improve the possibility of event success, further, if the distribution profit or the distribution rate of the distribution profit is raised by the seller, the event join desires of the members can be strongly stimulated, thereby rapidly and reliably achieving the target amount of product sales.

The sales profit distribution system 200 can obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 270, which is obtained by the events, is kept to a very large amount of money. Therefore, a cyber money mortgage or secondary outsourcing investment can be conducted by means of the use of the system usage fees, the withdrawal fees, and the cash balance in the system account, thereby creating great profits.

The members may withdraw the cyber money from their cyber money accounts and encash the cyber money, or they may get a loan against their cyber money from the sales profit distribution system 200. The members can encash their cyber money with a payment of the withdrawal fees, but in this case, an amount of cyber money retained in the cyber money account is decreased to cause the distribution order of the event to be undesirably lowered. So as to perform the encashing of the cyber money in the state where the amount of cyber money retained is kept, accordingly, the sales profit distribution system 200 may lend cash to the members with their cyber money as collateral. As a result, the sales profit distribution system 200 may do a financial business.

Now, an explanation on more improved effects obtained by increasing the distribution profit and the distribution rate of the distribution profit through the seller in the sales profit distribution system 200 and method according to implementations of the disclosed technology will be given with a given example.

A famous fitness center A sells a three-year membership X at a retail price of 3,000 dollars. The maximum number of three-year memberships X sold for a day in the fitness center A is 10. Actually, the three-year membership X is sold at the lowest price of 2,800 dollars on on-line markets, and the sales profit obtained when one three-year membership X is sold at the fitness center A is 1,650 dollars.

The fitness center A determines that they sell the three-year membership X at the lowest price of 2,800 dollars through the sales profit distribution system according to implementations of the disclosed technology, and the event is configured with the following conditions.
Sales price: 2,800 dollars
Target period of time for product sales: one day
Target amount of product sales: 1,000
Distribution profit to be distributed to purchasers if the event is successful: 1,300,000 dollars
Distribution way of the distribution profit: distribution according to payment order of purchase confirmation purchasers
Distribution rate of the distribution profit: 0.6%

The fitness center A can accomplish the number of memberships sold that is more increased by 100 times than the number of memberships sold for one day in the past, for only one day, which is the same period as in the past, so that the fitness center A obtains additional cash of 2,772,000 dollars (=2,800 dollars*990) greater than cash of 30,000 dollars for one day in the past.

Further, the fitness center A obtains additional sales profit of 1,633,500 dollars (=1,650 dollars*990) greater than a sales profit of 16,500 dollars for one day in the past.

The distribution profit of 1,300,000 dollars corresponding to about 78% of the additional sales profit is distributed to the purchasers (If it is desired for the fitness center to sell 990 three-year memberships in the conventional manner, a period of at least about three months is needed, and even after about the three months, of course, selling of the 990 three-year memberships cannot be ensured).

Purchaser B is a first purchaser who is in the first payment order among the 1,000 purchasers, Purchaser C is a second payment order, Purchaser D is in the 500th payment order, and Purchaser E is in 1,000th payment order. In this case, the cyber money to be distributed to Purchasers B, C, D and E will be calculated as follows.

[Amount to be Paid to Purchaser B]
Individual distribution profit of 7,800 dollars [=distribution profit of 1,300,000 dollars*distribution rate of 0.6%)]

[Amount to be Paid to Purchaser C]
Individual distribution profit of 7,753 dollars [=(amount of 1,292,200 dollars calculated by subtracting the first individual distribution profit of 7,800 dollars from distribution profit of 1,300,000 dollars)*(distribution rate of 0.6%)]

[Amount to be Paid to Purchaser D]
Individual distribution profit of 387 dollars [=(amount of 64,528 dollars calculated by subtracting the individual distribution profits of up to 499th purchasers from distribution profit of 1,300,000 dollars)*(distribution rate of 0.6%)]

[Amount to be Paid to Purchaser E]
Individual distribution profit of 19 dollars [=(amount of 3,184 dollars calculated by subtracting the individual distribution profits of up to 999th purchasers from distribution profit of 1,300,000 dollars)*(distribution rate of 0.6%)]

Purchasers B, C, D and E purchase the three-year membership of 2,800 dollars, which is the same price as the lowest price sold on on-line markets. According to the event success, furthermore, Purchasers B, C, D and E have got the respective individual distribution profits of 7,800 dollars, 7,753 dollars, 387 dollars, and 19 dollars in the form of cyber money. With a payment of the withdrawal fee, the cyber money in the cyber money account may be transferred to the cash account or cash may be withdrawn directly from the cyber money account, thereby increasing the cash assets of the purchaser. Further, Purchasers B and C who are in the first and second distribution order can earn a great amount of money, which is more than the price of the three-year membership. Their wealth is increased through their consumption.

Through the two examples as mentioned above, it can be appreciated that the sales profit distribution system according to implementations of the disclosed technology provides a consuming-tech (consumption+financial technology) system that increases wealth through consumption, and as large consumption is made, wealth is increased, so that consumption, deal and turnover ratio are optimized to achieve the advancement into a new economic paradigm unlike the conventional economic paradigm.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve described results. Moreover, the separation of various system components in the embodiments described in this patent document should not be understood as requiring such separation in all embodiments. Only a few implementations and examples are described. Other implementations, enhancements and variations can be made based on what is described and illustrated in this patent document.

What is claimed is:

1. A sales profit distribution system for distributing a distribution profit to a purchaser who purchases a product when a target amount of product sales is reached within a target period of time for the product sales, the sales profit distribution system comprising:
a product payment unit adapted to allow a payment for the product to be made through a terminal of the purchaser; and
a profit distribution unit adapted to calculate an individual distribution profit to be distributed to the purchaser from the distribution profit.

2. The sales profit distribution system according to claim 1, wherein the profit distribution unit performs a method of calculating the individual distribution profit, the method comprising the steps of:
arranging the purchasers in an order of payment;
paying a first individual distribution profit calculated by multiplying the distribution profit by a distribution rate of the distribution profit to a first purchaser who performs an earliest payment among the purchasers; and
paying a second individual distribution profit calculated by multiplying an amount remained after subtracting the first individual distribution profit from the distribution profit by the distribution rate of the distribution profit to a second purchaser who performs a second earliest payment among the purchasers.

3. The sales profit distribution system according to claim 1, further comprising a member account unit allocated to a member who is joined in the sales profit distribution system to deposit at least one of cyber money and cash thereinto,
wherein the profit distribution unit performs a method of calculating the individual distribution profit, the method comprising the steps of:
arranging the purchasers in an order of a cyber money amount deposited into member account unit of the purchaser;
paying a first individual distribution profit calculated by multiplying the distribution profit by the distribution rate of the distribution profit to a first purchaser who has a largest cyber money amount among the purchasers; and
paying a second individual distribution profit calculated by multiplying an amount remained after subtracting the first individual distribution profit from the distribution profit by the distribution rate of the distribution profit to a second purchaser who has a second largest cyber money amount among the purchasers.

4. The sales profit distribution system according to claim 1, further comprising a member account unit allocated to a member who is joined in the sales profit distribution system to deposit at least one of cyber money and cash thereinto,
wherein the profit distribution unit performs a method of calculating the individual distribution profit, the method comprising the steps of:
arranging the purchasers in an order of a value calculated by multiplying a cyber money amount deposited into the member account unit of the purchaser by the number of the payments of the purchaser (hereinafter, referred to as a “cyber money amount for order”);
paying a first individual distribution profit calculated by multiplying the distribution profit by the distribution rate of the distribution profit to a first purchaser who has a largest cyber money amount for order among the purchasers; and
paying a second individual distribution profit calculated by multiplying an amount remained after subtracting the first individual distribution profit from the distribution profit by the distribution rate of the distribution profit to a second purchaser who has a second largest cyber money amount for order among the purchasers.

5. The sales profit distribution system according to claim 1, further comprising a purchase confirmation management unit adapted to transmit a purchase confirmation request to a terminal of the purchaser and to receive a purchase confirmation response or a purchase cancel response as a response to the purchase confirmation request from the terminal of the purchaser,
wherein the profit distribution unit performs a method of calculating the individual distribution profit, the method comprising the steps of:
arranging the purchasers in an order of purchase confirmation response;
paying a first individual distribution profit calculated by multiplying the distribution profit by the distribution rate of the distribution profit to a first purchaser who transmits an earliest purchase confirmation response among the purchasers; and
paying a second individual distribution profit calculated by multiplying an amount remained after subtracting the first individual distribution profit from the distribution profit by the distribution rate of the distribution profit to a second purchaser who transmits a second earliest purchase confirmation response among the purchasers.

6. A sales profit distribution method through a sales profit distribution system for distributing a distribution profit to a purchaser who purchases a product when a target amount of product sales is reached within a target period of time for the product sales, the method comprising the steps of:
(a) performing a payment for the product by a terminal of the purchaser through a product payment unit; and
(b) calculating an individual distribution profit to be distributed to the purchaser from the distribution profit through a profit distribution unit.

7. The sales profit distribution method according to claim 6, wherein the step (b) comprises the steps of:
arranging the purchasers in an order of payment;
paying a first individual distribution profit calculated by multiplying the distribution profit by a distribution rate of the distribution profit to a first purchaser who performs an earliest payment among the purchasers; and
paying a second individual distribution profit calculated by multiplying an amount remained after subtracting the first individual distribution profit from the distribution profit by the distribution rate of the distribution profit to a second purchaser who performs a second earliest payment among the purchasers.

8. The sales profit distribution method according to claim 6, wherein the step (b) comprises the steps of:
arranging the purchasers in an order of a cyber money amount deposited into member account unit of the purchaser;
paying a first individual distribution profit calculated by multiplying the distribution profit by the distribution rate of the distribution profit to a first purchaser who has a largest cyber money amount among the purchasers; and
paying a second individual distribution profit calculated by multiplying an amount remained after subtracting the first individual distribution profit from the distribution profit by the distribution rate of the distribution profit to a second purchaser who has a second largest cyber money amount among the purchasers.

9. The sales profit distribution method according to claim 6, wherein the step (b) comprises the steps of:
arranging the purchasers in an order of a value calculated by multiplying a cyber money amount deposited into the member account unit of the purchaser by the number of the payments of the purchaser (hereinafter, referred to as a “cyber money amount for order”);
paying a first individual distribution profit calculated by multiplying the distribution profit by the distribution rate of the distribution profit to a first purchaser who has a largest cyber money amount for order among the purchasers; and
paying a second individual distribution profit calculated by multiplying an amount remained after subtracting the first individual distribution profit from the distribution profit by the distribution rate of the distribution profit to a second purchaser who has a second largest cyber money amount for order among the purchasers.

10. The sales profit distribution method according to claim 6, further comprising, before the step (b), the steps of transmitting a purchase confirmation request to a terminal of the purchaser and receiving a purchase confirmation response or a purchase cancel response as a response to the purchase confirmation request from the terminal of the purchaser through a purchase confirmation management unit,
wherein the step (b) comprises the steps of:
arranging the purchasers in an order of purchase confirmation response;
paying a first individual distribution profit calculated by multiplying the distribution profit by the distribution rate of the distribution profit to a first purchaser who transmits an earliest purchase confirmation response among the purchasers; and
paying a second individual distribution profit calculated by multiplying an amount remained after subtracting the first individual distribution profit from the distribution profit by the distribution rate of the distribution profit to a second purchaser who transmits a second earliest purchase confirmation response among the purchasers.
